(19) United States
(12) Patent Application Publication
(10) Pub. No.: US 2004/0133896 A1
(43) Pub. Date: Jul. 8, 2004

(54) Network device application interface

(75) Inventors: Kevin K. Lym, San Jose, CA (US); Naoyuki Sato, Campbell, CA (US); Jadie Sun, Millbrae, CA (US)

Correspondence Address: HAVERSTOCK & OWENS LLP, 162 NORTH WOLFE ROAD, SUNNYVALE, CA, 94086, US

(73) Assignee: Sony Corporation and Sony Electronics, Inc.

(21) Appl. No.: 10/327,573

(22) Filed: Dec. 20, 2002

(51) Int. Cl. G06F 9/00

(52) U.S. Cl. 719/315; 719/320

(57) ABSTRACT

A network device application programming interface (API) provides an interface to control and receive events from network devices. The network device API preferably resides within a control device, which is coupled to a network of devices. Each network device preferably uses IP-based protocols for sending control commands, and for receiving responses to the commands and asynchronous events. The network device API provides an interface that can be used across many different platforms. The interface is used as part of an application or as a standalone application. The network device API also provides a framework for defining and implementing a device control protocol. The framework for defining and implementing the device control protocol provides common functionality across multiple control and eventing protocols.

### FIELD OF THE INVENTION

The present invention relates to the field of transmitting information between devices. More particularly, the present invention relates to the field of providing an interface to applications involved in the transmission between devices over a bus or network.

### BACKGROUND OF THE INVENTION

The Universal Plug and Play (UPnP) standard is designed to enable simple and robust connectivity among stand-alone devices and personal computers (PCs) from many different vendors. With UPnP, a device can dynamically join a network, obtain an Internet Protocol (IP) address, convey its capabilities, and learn about the presence and capabilities of other devices. Devices can subsequently communicate with each other directly, thereby enabling discovery and control of devices. UPnP uses standard Transmission Control Protocol/Internet Protocol (TCP/IP) and Internet protocols which facilitates interoperability with existing networks.

The basic building blocks of a UPnP network are devices, services and control points. A UPnP device is a container of services and nested devices. Different categories of UPnP devices are associated with different sets of services and embedded devices. For instance, services within a VCR are different than those within a printer. The set of services provided by a particular device, as well as a list of properties associated with the particular device, are referred to in a device description document that the device must host. Preferably this device description document is written in Extensible Markup Language (XML).

A service exposes actions and models its state with state variables. For instance, a clock service can be-modeled as having a state variable, current time, which defines the state of the clock, and two actions, set_time and get_time, which enables control of the service. Similar to the device description, this information is part of a service description document preferably written in XML. The UPnP Forum defines UPNP Device and Service Descriptions according to a common device architecture. A pointer, such as a Uniform Resource Locator (URL), to each appropriate service description document is included within a device description document. Devices may include multiple services.

A service in a UPnP device includes a state table, a control server and an event server. The state table models the state of the service through state variables and updates them when the state changes. The control server receives action requests, such as set_time, executes the action requests, updates the state table and returns responses. The event server publishes events to interested subscribers anytime the state of the service changes. For instance, a fire alarm service sends an event to interested subscribers when its state changes to “ringing.”

A control point in a UPnP network is a controller capable of discovering and controlling other devices. After discovery of a network device, a control point can retrieve the device description and get a list of associated services, retrieve service descriptions for available services and invoke actions to control the service. The control point can also subscribe to the service's event source such that anytime the state of the service changes, the event server sends an event to the control point.

UPnP uses open, standard protocols such as TCP/IP, HyperText Transport Protocol (HTTP) and XML. Using these standardized protocols aids in ensuring interoperability between vendor implementations. Other technologies can also be used to network devices together. Such technologies include networking technologies such as Home Audio Video Interoperability (HAVi), Consumer Electronic Bus (CEBus), LonWorks, European Installation Bus (EIB), or X10. These too can participate in the UPnP network through a UPnP bridge or proxy.

A conventional protocol stack used to implement UPnP is illustrated in FIG. 1. The protocol stack includes a TCP/IP networking protocol stack 10, an HTTP layer 18, an HTTPU (HTTP unicast over User Datagram Protocol (UDP)) layer 20, an HTTPMU (HTTP multicast over UDP) layer 22, an SSDP (Simple Service Discovery Protocol) layer 24, a GENA (General Event Notification Architecture) layer 26, a SOAP (Simple Object Access Protocol) layer 28, a UPnP Device Architecture Defined layer 30, a UPnP Forum Working Committee Defined layer 32 and a UPNP Vendor Defined layer 34. The TCP/IP protocol stack 10 includes an IP layer 16, a TCP layer 14 and a UDP layer 12. The TCP/IP networking protocol stack 10 serves as the base on which the rest of the UPnP protocols are built. By using the standard, prevalent TCP/IP protocol suite, UPnP leverages the protocol's ability to span different physical media and ensures multiple vendor interoperability. UPnP devices can use many of the protocols in the TCP/IP protocol suite including TCP, UDP, IGMP (Internet Group Multicast Protocol), ARP (Address Resolution Protocol) and IP as well as TCP/IP services such as DHCP (Dynamic Host Configuration Protocol) and DNS (Domain Name System). TCP/IP provides the base protocol stack for network connectivity between UPnP devices.

All aspects of UPnP build on top of HTTP or its variants. HTTPU and HTTPMU are variants of HTTP defined to deliver messages on top of UDP/IP instead of TCP/IP. HTTPU and HTTPMU are protocols used by SSDP, which is described below. The basic message format used by HTTPU and HTTPMU adheres with that of HTTP and is required both for multicast communication and when message delivery does not require the overhead associated with reliability.

SSDP allows how network devices can be discovered on the network. SSDP is built on HTTPU and HTTPMU and defines methods both for a control point to locate resources on the network, and for devices to announce their availability on the network. By defining the use of both search requests and presence announcements, SSDP eliminates the overhead that would be necessary if only one of these mechanisms is used. As a result, every control point on the network has complete information on network state while keeping network traffic low.

Both control points and devices use SSDP. A UPnP control point, upon booting up, can send a multicast SSDP search request over HTTPMU to discover devices that are available on the network. The control point can refine the search to find only devices of a particular type, such as a VCR, particular services, such as devices with clock services, or even a particular device. UPnP devices listen to the multicast port. Upon receiving a search request, the device examines the search criteria to determine if they match. If a match is found, a unicast SSDP over HTTPU response is sent to the control point. Similarly, a device, upon being connected to the network, sends out multiple SSDP presence announcements advertising itself.

Both presence announcements and unicast device response messages include a pointer to the location of the device description document, which has information on the set of properties and services supported by the device.

The GENA layer provides the ability to send and receive event notifications using HTTP over TCP/IP and multicast UDP. The GENA layer also defines the concepts of subscribers and publishers of notifications to enable events. GENA formats are used in UPnP to create the presence announcements sent using SSDP and to provide the ability to signal changes in service state for UPnP eventing. A control point interested in receiving event notifications can subscribe to an event source by sending a request that includes the service of interest, a location to send the events to and a subscription time for the event notification. The subscription must be renewed periodically to continue to receive notifications, and the subscription can also be cancelled, using the GENA layer.

SOAP defines the use of XML and HTTP to execute remote procedure calls. By making use of the Internet's existing infrastructure, SOAP works effectively with firewalls and proxies. SOAP can also make use of SSL (Secure Socket Layer) for security and use of HTTP's connection management facilities. Much like remote procedure calls, UPnP uses SOAP to deliver control messages to devices and return results or errors back to control points. Each UPnP control request is a SOAP message that includes the action to invoke along with a set of parameters. The response is a SOAP message as well and includes the status, return value and any return parameters.

XML is a format for structured data on the web. XML is used to format device and service descriptions, control messages and eventing.

UPnP Vendor, UPnP Forum Working Committee and the UPnP Device Architecture define the highest layer protocols used to implement UPnP. The UPnP Device Architecture defines a schema or template for creating device and service descriptions for any device or service type. Individual working committees subsequently standardize on various device and service types and create a template for each individual device or service type. Finally, a vendor fills in this template with information specific to the device or service, such as the device name, model number, manufacturer name and URL to the device and service descriptions. This data is then encapsulated in the UPnP-specific protocols defined in the UPnP Device Architecture document, such as an XML device description template: The required UPnP specific information is inserted into all messages before they are formatted using SSDP, GENA, and SOAP and delivered via HTTP, HTTPU, or HTTPMU.

The process involved in UPnP networking includes addressing, discovery, description, control, eventing, and presentation. UPnP provides support for communication between control points and devices. The network media, the TCP/IP protocol suite and HTTP provide basic network connectivity and addressing needed. On top of these open, standard, Internet based protocols, UPnP defines a set of HTTP servers to handle discovery, description, control, events and presentation.

Each device includes a DHCP client that searches for a DHCP server when the device is first connected to the network. If a DHCP server is available, the device uses the IP address assigned to it. If no DHCP server is available, the device uses Auto IP to get an address.

Once devices are attached to the network and addressed appropriately, discovery can take place. Discovery is handled by the SSDP as discussed earlier. When a device is added to the network, SSDP enables the device to advertise its services to control points on the network. When a control point is added to the network, SSDP enables the control point to search for devices on the network. The fundamental exchange in both cases is a discovery message containing a few, essential specifics about the device or one of its services, for example its type, identifier, and a pointer to its XML device description document.

The next step in UPnP networking is description. After a control point discovers a device, the control point still knows very little about the device. For the control point to learn more about the device and its capabilities, or to interact with the device, the control point must retrieve the device's description from the URL provided by the device in the discovery message.

Devices can include other logical devices and services. The UPnP description for a device is preferably expressed in XML and includes vendor-specific, manufacturer information including the model name and number, serial number, manufacturer name, URLs to vendor-specific Web sites, and so forth. The description also includes a list of any embedded devices or services, as well as URLs for control, eventing, and presentation.

After the control point has retrieved a description of the device, the control point has the essentials for device control. To learn more about the service, the control point must retrieve a detailed UPnP description for each service. The description for a service is also preferably expressed in XML and includes a list of the commands, or actions, the service responds to, and parameters or arguments, for each action. The description for a service also includes a list of variables. These variables model the state of the service at run time, and are described in terms of their data type, range, and event characteristics.

To control a device, the control point sends an action request to a device's service. To do this, the control point sends a suitable control message to the control URL for the service that is provided in the device description. Control messages are expressed in XML using SOAP. In response to the control message, the service returns action specific values or fault codes.

A UPnP description for a service includes a list of actions the service responds to and a list of variables that model the state of the service at run time. The service publishes updates when these variables change, and a control point can subscribe to receive this information. The service publishes updates by sending event messages. Event messages include the names of one of more state variables and the current value of those variables. These messages are expressed in XML and formatted using GENA.

A special initial event message is sent when a control point first subscribes. This event message contains the names and values for all evented variables and allows the subscriber to initialize its model of the state of the service.

If a device has a URL for presentation, then the control point can retrieve a page from this URL, load the page into a browser, and depending on the capabilities of the page, allow a user to control the device and/or view device status. The degree to which each of these can be accomplished depends on the specific capabilities of the presentation page and device.

If applications are to be built on the services provided by the UPnP implementation, then an Application Programming Interface (API) is necessarily tailored to the platform the device is implemented on. APIs should enable all facets of UPnP including discovery, description, control, eventing and presentation.

### SUMMARY OF THE INVENTION

A network device application programming interface (API) provides an interface to control and receive events from network devices. The network device API preferably resides within a control device, which is coupled to a network of devices. Each network device preferably uses IP-based protocols for sending control commands, and for receiving responses to the commands and asynchronous events. The network device API provides an interface that can be used across many different platforms. The interface is used as part of an application or as a standalone application. The network device API also provides a framework for defining and implementing a device control protocol. The framework for defining and implementing the device control protocol provides common functionality across multiple control and eventing protocols.

In one aspect of the present invention, a control device is coupled to a network of devices. The control device includes one or more applications, network layer coupled to interface with one or more network devices, and an interface layer coupled to communicate with the applications and the network layer and provide control, query and event communications between the applications and one or more network devices. The interface layer includes a device object for each network device. Each device object includes one or more service objects and one or more event objects. The one or more service objects and the one or more event objects of each device object are coupled to the network layer. The device object includes a device description corresponding to the network device. The device description includes control and response functionality of the network device. The network is preferably an Internet Protocol (IP) based network. The interface layer is an application programming interface (API) and is protocol independent. The network layer preferably includes a Universal Plug and Play protocol stack and one or more network devices are Universal Plug and Play enabled devices.

In another aspect of the present invention, a method of providing an interface to applications resident within a control device coupled to a network of devices comprises sending and receiving messages to and from the applications through an interface layer regarding control commands to control one or more of the network devices by the applications, and generating and receiving communications at the interface layer to complete the control commands. Communications generated at the interface layer are sent to a network layer within the control device and communications received at the interface layer are received from the network layer. The network layer preferably includes a Universal Plug and Play protocol stack and one or more of the network devices are Universal Plug and Play enabled devices. The interface layer generates a device object for each network device to communicate with the network layer. The interface layer generates one or more service objects within the device object such that each service object corresponds to a service or a set of services provided by the network device corresponding to the device object. The interface layer generates one or more event objects within the device object such that each event object corresponds to an event associated with the network device corresponding to the device object.

In yet another aspect of the present invention, a method of providing an interface to applications resident within a control device coupled to a network of devices comprises creating a device object corresponding to a network device, creating one or more service objects within the device object wherein each service object corresponds to a service or a set of services provided by the network device, creating one or more event objects within the device object wherein each event object corresponds to an event associated with the network device, and providing control, query and event communications between a network layer and the service and event objects, wherein the control device uses the device object to provide control commands to the network device.

In still yet another aspect of the present invention, an application programming interface (API) used by a control device comprises a plurality of interfaces to define control and response functionality of a network device coupled to the control device, an input-output class to handle input and output functionality of the control device, and a data container class to define a data object corresponding to the network device, wherein the API provides control, query and event communications between the network device and an application resident within the control device.

### BRIEF DESCRIPTION OF THE DRAWINGS

FIG. 1 illustrates a conventional protocol stack used to implement the Universal Plug and Play standard.

FIG. 2 illustrates an exemplary network of devices.

FIG. 3 illustrates a block diagram of an exemplary hardware system resident in each system implementing the network device API of the present invention.

FIG. 4 illustrates a protocol according to the present invention.

### DETAILED DESCRIPTION OF THE EMBODIMENTS

Embodiments of the present invention include a network device application programming interface (API) that provides an interface to control and receive events from network devices. The network device API of the present invention preferably resides within a control device, where the control device can also be a network device. Each network device preferably uses IP-based protocols for sending control commands, and for receiving responses to the commands and asynchronous events. The network device API is designed to provide a simple and thin interface that can be used across many different platforms. The interface is preferably used as part of a web browser-based application. Alternatively, the interface is used as part of other applications or as a standalone application. The network device API of the present invention also provides a framework for defining and implementing a device control protocol. The device control protocol is preferably IP-based. Alternatively, the framework for defining and implementing the device control protocol provides common functionality across multiple control and eventing protocols. As such, the network device API of the present invention enables the framework to be extensible.

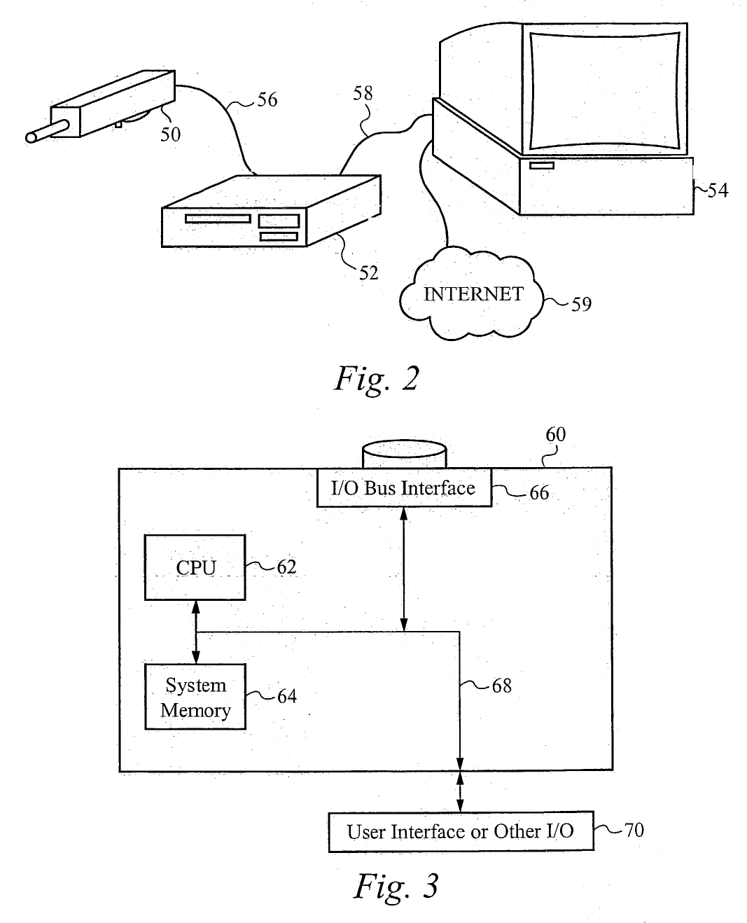

FIG. 2 illustrates an exemplary network of devices including a video camera 50, a video cassette recorder 52 and a computer 54 connected together by the input/output (I/O) busses 56 and 58. The I/O bus 56 couples the video camera 50 to the video cassette recorder 52, allowing the video camera 50 to send data to the video cassette recorder 52 for recording. The I/O bus 58 couples the video cassette recorder 52 to the computer 54, allowing the video cassette recorder 52 to send data to the computer 54 for display. At least one of the devices on the network is preferably coupled to the Internet to access device description information. Preferably, the computer 54 is coupled to the Internet 59. Alternatively, the computer 54 is coupled to any network that includes device description information.

In the preferred embodiment of the present invention, each of the subsystems, including the video camera 50, the video cassette recorder 52 and the computer 54 are Universal Plug and Play (UPnP) enabled. Within the exemplary network of devices of FIG. 2, the computer 54 is a control device. As such, the computer 54 includes an interface layer implementing the network device API according to the present invention for providing control, query, and event communications between the computer 54, the video camera 50, and the video cassette recorder 52. The computer 54 also includes an API for discovering the presence of the network devices, which in this case include the video camera 50 and the video cassette recorder 52. This API is preferably a device discovery API as described in the co-pending U.S. patent application Ser. No. ______ filed on ______ and entitled “Device Discovery Application Interface” which is also hereby incorporated by reference. It should be understood by those skilled in the art that any other API can be used that provides an interface discovery communications between a control device and a network device. It is also understood that an interface layer implementing the network device API and the device discovery API can also be implemented within any one or all connected subsystems within the network, including the video camera 50, the video cassette recorder 52 or the computer 54, which is capable of discovering a network device and using the network device API of the present invention to control the discovered network device.

A block diagram of an exemplary hardware system resident in each system implementing the interface layer of the present invention is illustrated in FIG. 3. In the hardware system illustrated in FIG. 3, a printed circuit board 60 is coupled to a user interface 70. The printed circuit board 60 includes a central processing unit (CPU) 62 coupled to system memory 64 and to an I/O bus interface 66 by a system bus 68. The user interface 70 is also coupled to the system bus 68. The user interface 70 is subsystem specific, but can include a keyboard, display or other I/O devices for communicating with a user of the subsystem. It should be apparent to those skilled in the art that there may be some devices implementing the interface layer of the present invention which do not include the user interface 70, such as a hard disk drive or similar device.

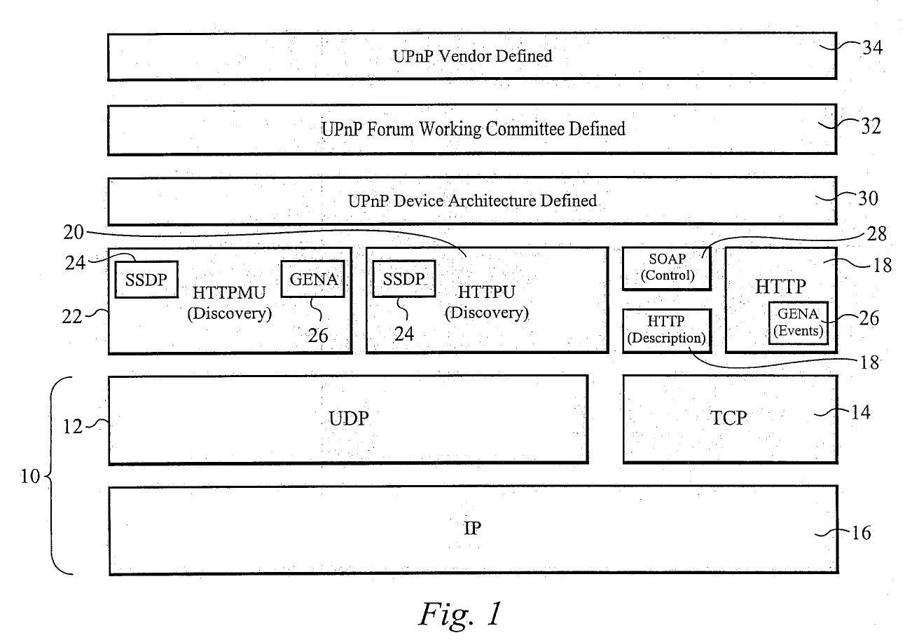

Each subsystem intending to implement the interface layer of the present invention will preferably include a hardware system such as the system illustrated in FIG. 3. As applied to the network of devices illustrated in FIG. 2 in which the computer 54 is a control device, the computer 54 includes the hardware system of FIG. 3. The CPU 62 within the computer 54 is used to execute the appropriate program instructions. The interface layer of the present invention will then provide a simplified interface between applications resident within the computer 54 and a network layer, such as the UPnP protocol stack illustrated in FIG. 1.

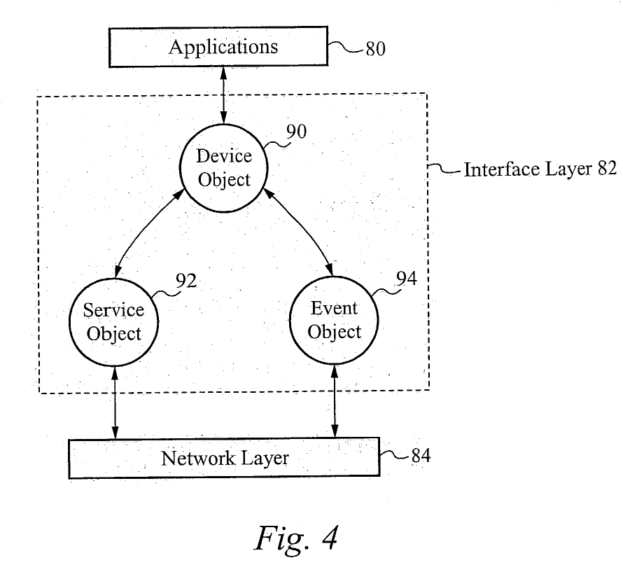

A protocol according to the present invention is illustrated in FIG. 4. One or more applications 80 are coupled to an interface layer 82 in order to communicate control commands taking place between the applications 80 included within the computer 54 and one or both of the video camera 50 and the video cassette recorder 52. The interface layer 82 is also coupled to communicate with a network layer 84 for generating necessary control, query and event communications with the video camera 50 and/or the video cassette recorder 52. The network layer 84 represents a supported protocol stack such as the UPnP protocol stack illustrated in FIG. 1. The applications 80, the interface layer 82 and the network layer 84 are resident within the control device, such as the computer 54. The interface layer 82 communicates with the applications 80 and the network layer 84 as necessary to provide control commands to and from the applications 80.

The interface layer acts as an abstraction layer such that an application can provide control commands to a network device without knowing the specific type and associated protocols of the network device. The interface layer 82 preferably implements the network device API of the present invention. The interface layer 82 includes a device object 90 coupled to the one or more applications 80. The device object 90 includes one or more service objects 92 and one or more event objects 94. The service objects 92 and the event objects 94 are coupled to the network layer 84.

A device object is created for each network device discovered by the control device. In the case of the exemplary network of FIG. 3, a device object 90 is created for each of the video camera 50 and the video cassette recorder 52. The device object 90 is comprised of multiple interfaces, an input-output class and a generic data container class. The interfaces define basic control and response functionality of a network device. The functionality includes sending control commands to the network device and receiving responses back, sending query commands to the network device and receiving responses back, subscribing to and receiving event type information from the network device, and storing and retrieving information about the network device. An additional interface is provided for callbacks that may be implemented.

The input-output class provides a system and browser independent interface for input-output functions, such as sending a message string out on a designated port, creating and/or deleting a port, and receiving a message string.

The data container class defines a data object that is passed to and from the methods defined by each network device's device object. The data container class can represent and store a wide range of data types that can be used by the device object's methods. Since all data being passed between the control device and the network device are strings, the data container class basically includes the string representation of the data and the data type the string represents. Any application using this data must convert the data to its “true” data type.

As described above, the network device API is comprised of multiple interfaces used to build each network device object. A data object for a particular class of network devices, for example a UPnP Device class for a network device operating according to the UPnP protocol illustrated in FIG. 1, must be defined, such that the interfaces are used to fill out the class. The constructor of the class loads in the device description information and stores the information for use by all of the methods of the class. The constructor also sets up the communication ports. All protocol dependent functionality is included in the network device class.

The device description references a listing of services offered by the network device. A service is a group of actions the network device provides that can be accessed and/or invoked. The services available are either events or control services. Control services are actions that control a device. For example, a service for a VCR can be transport control, such that the actions for transport control include play, stop, and fast-forward. The transport control service can also include status information, such as the state of the transport, which can be queried. An event is an asynchronous action that occurs on a network device. Using the VCR example again, the ejection of the tape can be an event since the action occurs asynchronously.

The services are preferably implemented as an inner class of the network device class. Defining the service as an inner class allows an object to be created per a set of services that is needed by the client. Such an object corresponds to a service object 92 in FIG. 4. From each service object, control and query actions can be invoked. Control and query actions are invoked through control and query methods. These methods either invoke an action by sending a command, or retrieve state or status data from the network device.

Event objects are created to provide event notification asynchronously to all subscribers of the event object. An event object is preferably created for each event service provided by a network device. Such an event object corresponds to an event object 94 in FIG. 4. Each event can be subscribed to or unsubscribed to by event methods included within the event object. Preferably, a handler passed into the constructor handles the event messages.

A NetworkDeviceIO class is preferably used to handle all input and output functionality. All application specific input-output is preferably implemented in this class. This allows portability of the network device object across all applications. All handlers that are passed-in are registered with a general input handler defined by the NetworkDeviceIO class.

In summary, the network device API of the present invention is an abstraction layer for an application within a control device. The network device API of the present invention is resident within the control device and is used by the control device to communicate control commands to a target, or network device. In the case where the network device is a UPnP enabled device, the network device API is the abstraction layer above the UPnP protocol. For each network device, the network device API creates a device object based on a discovered device description. From the device description, available services and events are listed, from which service objects and event objects are created. Within each service object there are methods to invoke the actions for that service. Similarly, within each event object, there are methods to subscribe to, or unsubscribe to, an event such that when the event occurs an event notification is asynchronously sent to all subscribers.

Although the network device API of the present intention is preferably used as an abstraction layer between an application and a UPnP protocol, it is understood that the network device API can also be used as an abstraction layer on top of other network and device protocols.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill that while the preferred embodiment of the present invention is used with Universal Plug and Play enabled devices, the present invention can also be implemented on any other appropriate network device, or with any other appropriate protocols.

What is claimed is:

1. A control device coupled to a network of devices the control device comprising:
a. one or more applications;
b. a network layer coupled to interface with one or more network devices; and
c. an interface layer coupled to communicate with the applications and the network layer and provide control, query and event communications between the applications and one or more network devices.

2. The control device of claim 1 wherein the interface layer comprises a device object for each network device.

3. The control device of claim 2 wherein each device object includes one or more service objects and one or more event objects.

4. The control device of claim 3 wherein the one or more service objects and the one or more event objects of each device object are coupled to the network layer.

5. The control device of claim 2 wherein the device object includes a device description corresponding to the network device.

6. The control device of claim 5 wherein the device description includes control and response functionality of the network device.

7. The control device of claim 1 wherein the network is an Internet Protocol (IP) based network.

8. The control device of claim 1 wherein the interface layer is an application programming interface (API).

9. The control device of claim 1 wherein the interface layer is protocol independent.

10. The control device of claim 1 wherein the network layer includes a Universal Plug and Play protocol stack.

11. The control device of claim 10 wherein one or more network devices are Universal Plug and Play enabled devices.

12. A network comprising:
a. one or more network devices; and
b. a control device comprising:
i. one or more applications;
ii. a network layer coupled to interface with the one or more network devices; and
iii. an interface layer coupled to communicate with the applications and the network layer and provide control, query and event communications between the applications and the one or more network devices.

13. The network of claim 12 wherein the interface layer comprises a device object for each network device.

14. The network of claim 13 wherein each device object includes one or more service objects and one or more event objects.

15. The network of claim 14 wherein the one or more service objects and the one or more event objects of each device object are coupled to the network layer.

16. The network of claim 13 wherein the device object includes a device description corresponding to the network device.

17. The network of claim 16 wherein the device description includes control and response functionality of the network device.

18. The network of claim 12 wherein the network is an Internet Protocol (IP) based network.

19. The network of claim 12 wherein the interface layer is an application programming interface (API).

20. The network of claim 12 wherein the interface layer is protocol independent.

21. The network of claim 12 wherein the network layer includes a Universal Plug and Play protocol stack.

22. The network of claim 21 wherein one or more network devices are Universal Plug and Play enabled devices.

23. A method of providing an interface to applications resident within a control device coupled to a network of devices, the method comprising:
a. sending and receiving messages to and from the applications through an interface layer regarding control commands to control one or more of the network devices by the applications; and
b. generating and receiving communications at the interface layer to complete the control commands.

24. The method of claim 23 wherein communications generated at the interface layer are sent to a network layer within the control device and communications received at the interface layer are received from the network layer.

25. The method of claim 24 wherein the network layer includes a Universal Plug and Play protocol stack and one or more of the network devices are Universal Plug and Play enabled devices.

26. The method of claim 24 wherein the interface layer generates a device object for each network device to communicate with the network layer.

27. The method of claim 26 wherein the interface layer generates one or more service objects within the device object such that each service object corresponds to a service or a set of services provided by the network device corresponding to the device object.

28. The method of claim 26 wherein the interface layer generates one or more event objects within the device object such that each event object corresponds to an event associated with the network device corresponding to the device object.

29. A method of providing an interface to applications resident within a control device coupled to a network of devices, the method comprising:
a. generating a device object corresponding to a network device;
b. generating one or more service objects within the device object wherein each service object corresponds to a service or a set of services provided by the network device;
c. generating one or more event objects within the device object wherein each event object corresponds to an event associated with the network device; and
d. providing control, query and event communications between a network layer and the service and event objects;
wherein the control device uses the device object to provide control commands to the network device.

30. An application programming interface (API) used by a control device, the API comprising:
a. a plurality of interfaces to define control and response functionality of a network device coupled to the control device;
b. an input-output class to handle input and output functionality of the control device; and
c. a data container class to define a data object corresponding to the network device wherein the API provides control, query and event communications between the network device and an application resident within the control device.
